(19) United States
(12) Patent Application Publication
(10) Pub. No.: US 2004/0149115 A1
(43) Pub. Date: Aug. 5, 2004

(54) Cut-forming machine and optical recording medium-manufacturing apparatus

(75) Inventors: Junichi Ide, Tokyo (JP); Haruhiko Yamaguchi, Tokyo (JP); Futoshi Kobayashi, Tokyo (JP); Tsuyoshi Itoh, Tokyo (JP); Takeshi Umega, Tokyo (JP); Yoshimi Yodogawa, Tokyo (JP); Mamoru Usami, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/762,245

(22) Filed: Jan. 23, 2004

(30) Foreign Application Priority Data
Jan. 23, 2003 (JP) 2003-14366

(51) Int. Cl. B26D 11/00

(52) U.S. Cl. 83/862; 83/100; 83/582

(57) ABSTRACT

There is provided a cut-forming machine which is capable of preventing movement of a substrate caused by movement of a cut-forming blade section, a vertical movement mechanism moves at least one of a table for supporting a disk-shaped substrate and a cut-forming blade section toward the other of them, thereby pushing the cut-forming blade section into a light transmission layer of the substrate. A spring urges an urging portion disposed in a central portion of the cut-forming blade section, from at least a time point of completion of pushing the cut-forming blade section into the light transmission layer to a time point of removal of the cut-forming blade section from the light transmission layer, thereby causing the urging portion to urge a central portion of the disk-shaped substrate toward the table.

### BACKGROUND OF THE INVENTION

1. Field of the Invention

The present invention relates to a cut-forming machine that forms a cut in a resin layer of a disk-shaped substrate before a central hole is punched therethrough, and an optical recording medium-manufacturing apparatus that incorporates the cut-forming machine and a punching machine, and manufactures an optical recording medium.

2. Description of the Related Art

In general, when an optical recording medium (optical disk), such as a CD or a DVD, is manufactured, a thin film, such as a light-reflecting layer, is formed on a disk-shaped substrate having grooves and lands formed on a surface thereof by injection molding, and then a resin layer as a protective layer is formed on the thin film by the spin-coating method such that the protective layer covers the thin film. Further, when a writable optical recording medium, such as a CD-R, a CD-RW, a DVD-R, or a DVD-RW, is manufactured, thin films, such as a light-reflecting layer and a recording layer, are sequentially formed on a surface of a substrate, and then a resin layer as a protective layer is formed on top of the thin films by the spin-coating method such that the protective layer covers the thin films. If the optical recording media thus manufactured have variation in the film thickness of the resin layer thereof, it is difficult to reliably prevent damage from occurring to the thin film(s). Therefore, in the formation of a resin layer, it is necessary to spin-coat the entire surface of a substrate with a resin material for forming a resin layer, to a uniform thickness. Further, to form a resin layer having a uniform thickness on a substrate by the spin-coating method, it is preferable to drop a resin material onto the center of a substrate being rotated. However, it is necessary to form a central hole in the center of an optical recording medium, for enabling clamping (chucking) e.g. by a recording and reproducing apparatus, which makes it difficult to drop a resin material onto the center of a substrate during execution of spin-coating operation. To overcome this problem, the present inventors have proposed, in Japanese Patent Application No. 2002-196415, an optical recording medium-manufacturing apparatus (hereinafter also referred to as the “manufacturing apparatus”) which is configured to drop a resin material onto a substrate before forming a central hole, thereby forming a resin layer with a uniform thickness, and then punch the central hole such that the central hole extends through the substrate and the resin layer.

In the proposed manufacturing apparatus, first, an information-recording surface of a disk-shaped substrate (substrate) having no central hole formed in a central portion thereof is spin-coated with a resin for forming a light transmission layer. In this case, differently from the CD and the DVD of the type referred to hereinabove, an optical recording medium manufactured by the manufacturing apparatus proposed by the present inventors is configured such that in recording or reproducing record data, a laser beam is caused to enter the medium from a front surface side of a resin layer formed on a thin film. Therefore, in the manufacturing apparatus, when the optical recording medium is manufactured, a light transmission layer for transmitting a laser beam therethrough is formed in place of the protective layer in the above example. More specifically, an ultraviolet-curing resin, for example, is dropped onto the center (portion to be formed with a central hole afterwards) of a substrate being rotated by a coating device such that the resin material is caused to expand toward the periphery of the substrate by centrifugal force generated by rotation of the substrate. In doing this, the rotational speed of the substrate is properly adjusted, whereby the resin material is uniformly coated on the entire information-recording surface. Then, an ultraviolet ray is irradiated onto the resin coated on the substrate such that the resin is cured to form a light transmission layer.

Then, a circular cut having a diameter approximately equal to that of the central hole is formed in the light transmission layer in an area of the light transmission layer where a central hole is to be formed. More specifically, the substrate is rotated in a state where a blade of a tool is pushed into the light transmission layer, whereby a cut having a depth approximately equal to the thickness of the light transmission layer is formed in the light transmission layer. Subsequently, the substrate is transferred by a transfer mechanism from a processing location for forming a cut (hereinafter also referred to as the “cut-forming location”) to a location for forming a central hole (hereinafter also referred to as the “central hole-forming location”). Then, a hollow cylindrical punching tool is pushed into the substrate from the side where the light transmission layer is formed, to thereby punch a central hole through the substrate. In doing this, since the cut has been formed in the light transmission layer prior to punching the central hole, peeling-off or formation of burrs is prevented from occurring to the light transmission layer during formation of the central hole. By carrying out the steps described above, the optical recording medium is completed. Thereafter, the optical recording medium is transferred by the transfer mechanism from the central hole-forming location to a stack location for stacking completed optical recording media.

However, from the study of the proposed manufacturing apparatus, the present inventors found out the following points for improvement: In the proposed manufacturing apparatus, the substrate is rotated in a state where the cut-forming tool is pushed into the light transmission layer, whereby a cut having a depth approximately equal to the thickness of the light transmission layer is formed in the light transmission layer. In this case, when the cut-forming tool is moved after completion of forming the cut in the light transmission layer, the cut-forming tool and the substrate with the cut-forming tool stuck therein are sometimes moved together. In such a case, the efficiency in manufacturing optical recording media is degraded since an operator has to remove the substrate from the cut-forming tool by manual operation, and hence improvement in this point is desired. On the other hand, the inventors have proposed a manufacturing apparatus which is configured to use a hollow cylindrical tool in place of the above cut-forming tool, and bring a foremost end of the hollow cylindrical tool into pressure contact with the light transmission layer (push the former into the latter) to thereby form a cut in the light transmission layer. According to this configuration, a cut can be formed simply by pushing the foremost end of the hollow cylindrical tool into the light transmission layer, so that it is possible to form a cut in a shorter time period in comparison with the method of rotating a substrate in a state where the cut-forming tool is pushed into the light transmission layer. However, even in the case of the hollow cylindrical tool being used in place of the cut-forming tool, when the hollow cylindrical tool is moved after completion of forming a cut, the substrate is sometimes moved together with the hollow cylindrical tool which is stuck therein. Hence, improvement in this point is desired.

Further, in the manufacturing apparatuses proposed by the inventors, the depth by which the cut-forming tool or the hollow cylindrical tool is pushed into the light transmission layer is properly adjusted to thereby adjust the depth of a cut formed in the light transmission layer. In this case, it is difficult to adjust the amount of movement of the cut-forming tool or the hollow cylindrical tool (the depth by which the cut-forming tool or the hollow cylindrical tool is pushed into the light transmission layer), so that, for example, as shown in a left portion of FIG. 20, a shallow cut (16) is sometimes formed due to an insufficient amount of pushing of the hollow cylindrical tool (60) into the light transmission layer (14). In such a state, peeling-off or formation of burrs can occur to the light transmission layer (14) when a central hole is punched using the punching tool. Further, in the case of using a single-edged hollow cylindrical tool with a cutting edge provided on an inner periphery thereof, such as a hollow cylindrical tool (60x) shown in a right portion of FIG. 20, when the hollow cylindrical tool (60x) is moved upward after completion of forming a cut (16), an outer part of the light transmission layer (14) with respect to the cut (16) is sometimes peeled off the substrate (12) in a state of the part being caught by the outer peripheral surface of the hollow cylindrical tool (60x). Hence, it is required to avoid this inconvenience.

### SUMMARY OF THE INVENTION

The present invention has been made to solve the above described problems, and a first object thereof is to provide a cut-forming machine which is capable of preventing movement of a substrate cause by movement of a cut-forming blade section, and an optical recording medium-manufacturing apparatus incorporating the cut-forming machine. Further, a second object of the present invention is to provide a cut-forming machine which is capable of accurately and easily forming a cut which can reliably prevent peeling-off or burr formation, and an optical recording medium-manufacturing apparatus incorporating the cut-forming machine.

To attain the above object, in a first aspect of the present invention, there is provided a cut-forming machine for forming a circular cut in a resin layer formed on one side of a disk-shaped substrate to be formed with a central hole by a punching machine, such that the circular cut has a diameter larger than a diameter of the central hole and surrounds a portion of the disk-shaped substrate where the central hole is to be formed,

the cut-forming machine comprising:

a table for supporting the disk-shaped substrate with the resin layer facing upward;

a cut-forming blade section for forming the cut in the resin layer by being pushed into the resin layer, the cut-forming blade section having a hollow cylindrical shape;

a moving mechanism for moving at least one of the table and the cut-forming blade section toward the other of the table and the cut-forming blade section, thereby pushing the cut-forming blade section into the resin layer;

an urging portion that is disposed in a central portion of the cut-forming blade section such that the urging portion is allowed to slide in directions of movement of the at least one of the table and the cut-forming blade section, caused by the moving mechanism, toward and away from the other of the table and the cut-forming blade section; and

an urging device for urging the urging portion, from at least a time point of completion of pushing the cut-forming blade section into the resin layer by the moving mechanism to a time point of removal of the cut-forming blade section from the resin layer by the moving mechanism, thereby causing the urging portion to urge a central portion of the disk-shaped substrate toward the table.

To attain the above object, in a second aspect of the invention, there is provided an optical recording medium-manufacturing apparatus for manufacturing an optical recording medium by forming the central hole in the disk-shaped substrate, comprising:

the cut-forming machine recited above; and

the punching machine having a punching blade section for being pushed into the portion of the disk-shaped substrate where the central hole is to be formed, for punching the central hole.

According to the above cut-forming machine and the optical recording medium-manufacturing apparatus, the urging device causes the urging portion to urge the disk-shaped substrate toward the table from at least a time point of completion of pushing the cut-forming blade section into the resin layer by the moving mechanism to a time point of removal of the cut-forming blade section from the resin layer by the moving mechanism, whereby although a relatively simple construction is employed therefor, it is possible to avoid the inconvenience that when the cut-forming blade section is moved upward, the disk-shaped substrate having the cut-forming blade section stuck therein is moved upward together therewith. Therefore, it is no longer necessary, for example, for an operator to remove the disk-shaped substrate from the cut-forming blade section by manual operation. This makes it possible to further enhance the manufacturing efficiency of optical recording media.

Preferably, the urging device is implemented by a coil spring.

According to this preferred embodiment, since the urging device is implemented by a coil spring, the control of operation of the urging device becomes unnecessary differently from the construction in which air cylinders or an actuator urges the urging portion. Moreover, it is possible to manufacture the cut-forming machine and the optical recording medium-manufacturing apparatus at lower costs.

Preferably, the table has a positioning protrusion formed on a central portion thereof in a manner protruding therefrom, for being fitted into a positioning hole that is formed in the central portion of the disk-shaped substrate and has a diameter smaller than the diameter of the central hole.

According to this preferred embodiment, a positioning protrusion is formed on the central portion of the table in a manner protruding therefrom, for being fitted into the positioning hole formed in the central portion of the disk-shaped substrate whereby in forming a cut, it is possible to push the cut-forming blade section into the light transmission layer in the state where the central portion of the cut-forming blade section is aligned with the central portion of the disk-shaped substrate on the table, so that it is possible to positively avoid the inconvenience that the cut is formed off-center with respect to the central portion of the disk-shaped substrate.

Preferably, the cut-forming blade section has an annular blade formed on a bottom surface thereof such that the annular blade protrudes from the bottom surface by a length equivalent to a thickness of the resin layer, and the moving mechanism moves the cut-forming blade section such that the bottom surface of the cut-forming blade section is brought into surface contact with the surface of the resin layer.

According to this preferred embodiment, the cut-forming blade section having an annular blade formed on a bottom surface thereof in a manner protruding from the bottom surface by a length equivalent to a thickness of the resin layer is moved such that it is brought into surface contact with the surface of the resin layer. This makes it possible to accurately and easily form a cut having a desired depth while dispensing with complicated height control, etc.

Preferably, the cut-forming blade section is formed with either a single-edged blade having a cutting edge formed on an outer periphery thereof, or a double-edged blade having cutting edges formed on both of the outer periphery and an inner periphery thereof.

According to this preferred embodiment, since the cut-forming blade section is formed with either a single-edged blade having a cutting edge formed on an outer periphery thereof, or a double-edged blade having cutting edges formed on both of the outer periphery and an inner periphery thereof, it is possible to avoid the inconvenience that when the cut-forming blade section is moved upward, an outer part of the resin layer with respect to the cut is peeled off the substrate in a state of the outer part being caught by the outer peripheral surface of the blade.

It should be noted that the present disclosure relates to the subject matter included in Japanese Patent Application No. 2003-014366 filed on Jan. 23, 2003, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a block diagram showing the arrangement of a manufacturing apparatus according to an embodiment of the present invention;

FIG. 2 is a cross-sectional view of a disk-shaped substrate before a cut and a central hole are formed therein;

FIG. 3 is a cross-sectional view of an optical recording medium produced by the manufacturing apparatus;

FIG. 4 is a plan view showing the arrangement of the manufacturing apparatus;

FIG. 5 is a cross-sectional view showing the arrangement of a cut-forming machine of the manufacturing apparatus;

FIG. 6 is a cross-sectional view of respective blades of cut-forming blade sections of cut-forming machines, and disk-shaped substrates having cuts formed therein by the respective cut-forming blade sections;

FIG. 7 is a cross-sectional view showing the arrangement of a punching machine of the manufacturing apparatus;

FIG. 8 is a side view showing the arrangement of a collector of the manufacturing apparatus;

FIG. 9 is a cross-sectional view showing the arrangement of a cleaner of the manufacturing apparatus;

FIG. 10 is a fragmentary cross-sectional view of a transfer mechanism (transfer stage) of the manufacturing apparatus;

FIG. 11 is a cross-sectional view of the cut-forming machine in a state in which a disk-shaped substrate is sucked to a table of the cut-forming machine;

FIG. 12 is a cross-sectional view of the cut-forming machine in a state in which the blade of the cut-forming blade section is brought into abutment with the disk-shaped substrate in the state shown in FIG. 11;

FIG. 13 is a cross-sectional view of the cut-forming machine in a state in which the cut-forming blade section is moved upward after completion of forming a cut in the disk-shaped substrate;

FIG. 14 is a cross-sectional view of the punching machine in a state in which a positioning protrusion of the punching machine is fitted in a positioning hole of the disk-shaped substrate;

FIG. 15 is a cross-sectional view of the punching machine in a state in which the disk-shaped substrate is brought into abutment with a substrate-receiving table, after having been moved downward by an ultrasonic horn;

FIG. 16 is a cross-sectional view of the punching machine in a state in which a cutting edge of a punching blade section is pushed into the disk-shaped substrate by moving the disk-shaped substrate in the FIG. 15 state further downward;

FIG. 17 is a cross-sectional view of the punching machine in a state in which the ultrasonic horn is moved upward after the central hole is formed by punching;

FIG. 18 is a cross-sectional view of the cleaner in a state in which a blowing section of the cleaner is moved to a position over the central hole of the disk-shaped substrate, for cleaning;

FIG. 19 is a cross-sectional view of the cleaner in a state in which a peripheral surface of a nozzle of the blowing section is brought into abutment with a rim of the central hole by moving the blowing section in the FIG. 18 state further downward; and

FIG. 20 is a cross-sectional view of a state where a cut is formed in a light transmission layer by a hollow cylindrical tool, and a state where a hollow cylindrical tool is moved upward after completion of forming a cut.

### DESCRIPTION OF THE PREFERRED EMBODIMENTS

The invention will now be described in detail with reference to the accompanying drawings showing a preferred embodiment thereof.

First, a description will be given of the arrangement of an optical recording medium-manufacturing apparatus according to the present invention and the construction of an optical recording medium.

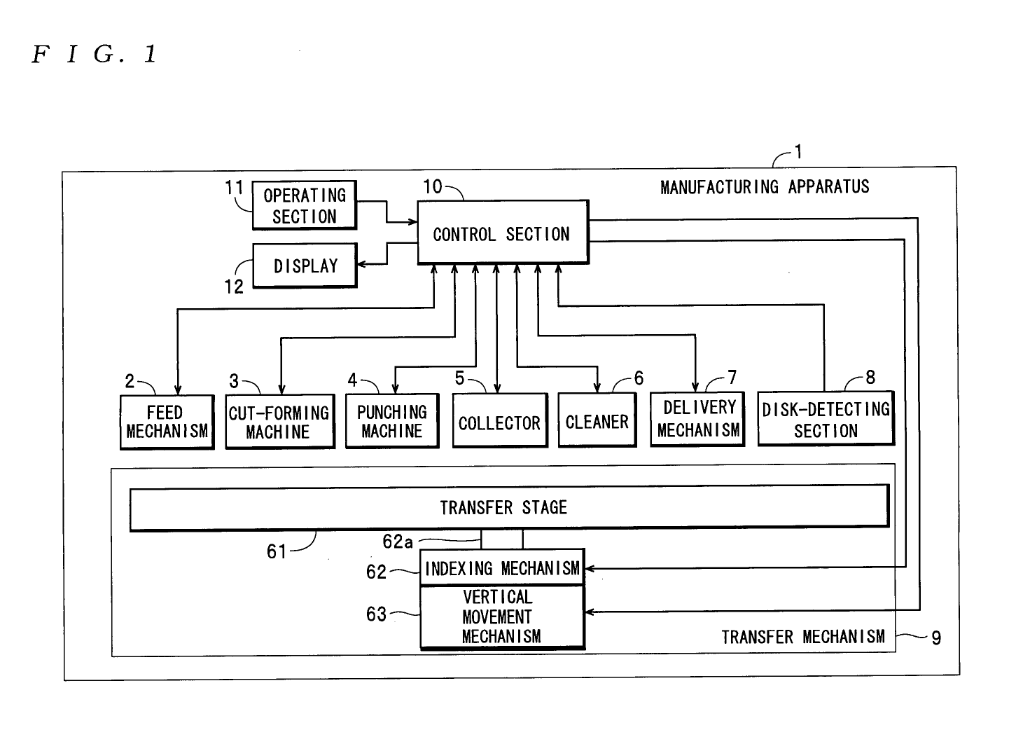

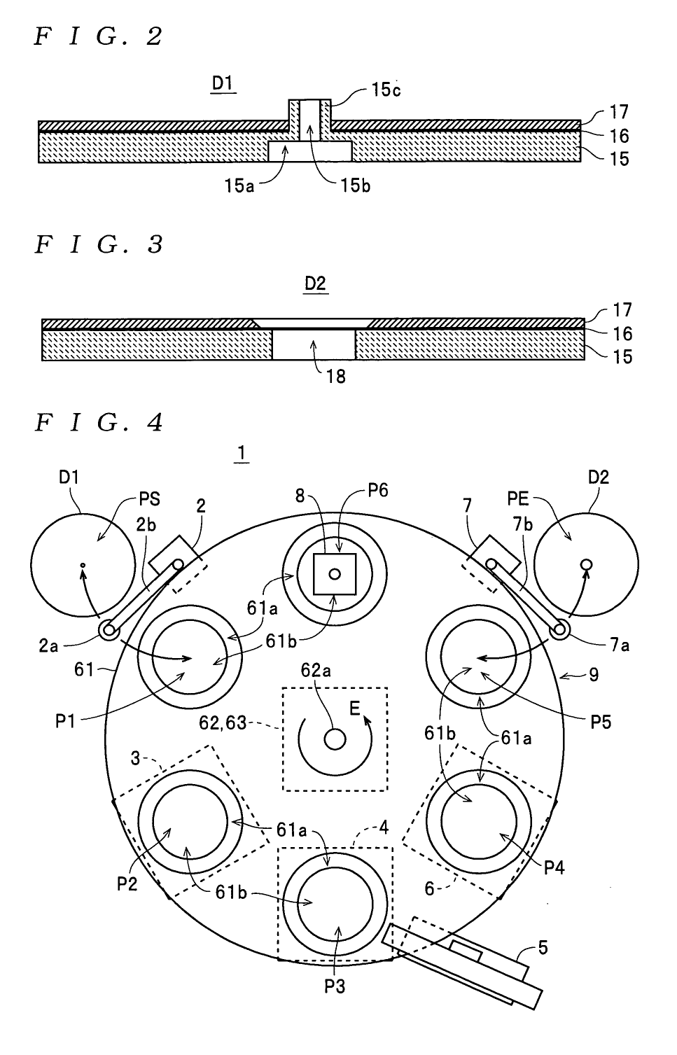

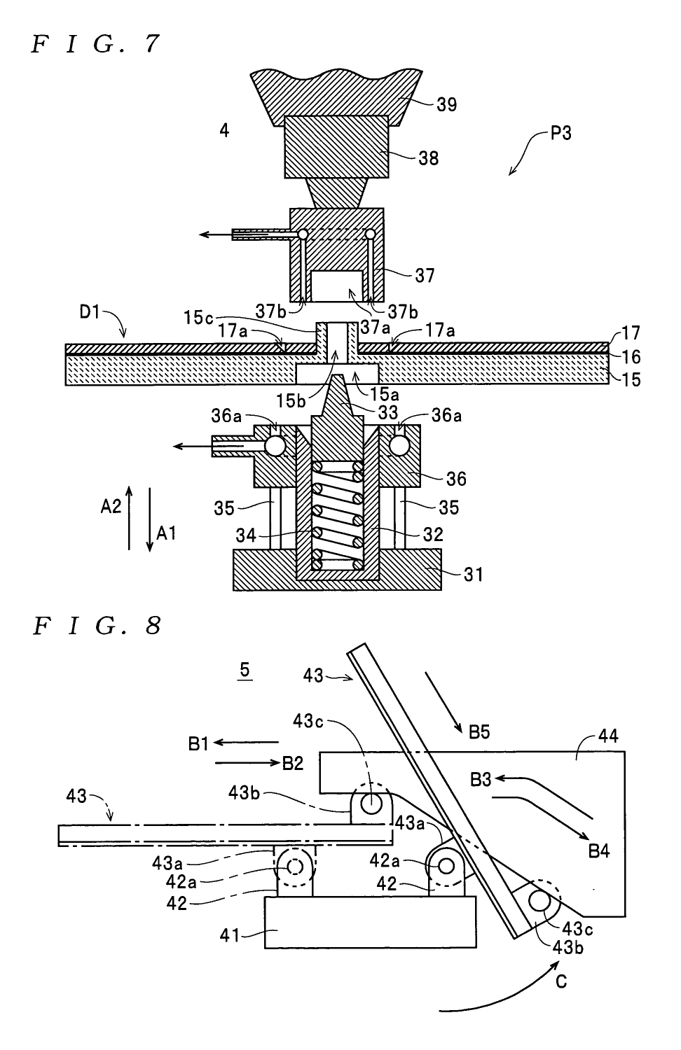

A manufacturing apparatus 1 shown in FIG. 1 corresponds to the optical recording medium-manufacturing apparatus according to the present invention, and manufactures an optical recording medium D2 (see FIG. 3) by forming a cut 17a (see FIG. 7) in a light transmission layer 17 of a disk-shaped substrate D1 (see FIG. 2; “disk-shaped substrate to be formed with a central hole by a punching machine” in the present invention), and then punching a central hole 18 therethrough. In this embodiment, as shown in FIG. 2, the disk-shaped substrate D1 is comprised of a substrate 15 in the form of a disk, thin films 16, such as a light-reflecting layer and a recording layer, sequentially formed on one or upper surface of the substrate 15, and the light transmission layer (resin layer in the present invention) 17 formed such that the layer 17 covers the thin films 16. The substrate 15 is molded by injecting a resin material, such as a polycarbonate, prior to preparation of the disk-shaped substrate D1. In the present embodiment, the other or lower surface of the substrate 15 has a central portion formed with a recess 15a whose bottom surface is to be punched afterwards for formation of the central hole 18. In the illustrated example, the recess 15a is formed to have a diameter of 15 mm, equal (equivalent) to the diameter of the central hole 18. Further, in the upper surface of the substrate 15, there are formed grooves and lands by injection molding, and a hollow cylindrical protrusion 15c formed with a positioning hole 15b for positioning the disk-shaped substrate D1 with respect to a cut-forming machine 3 and a punching machine 4 when the cut 17a and the central hole 18 are formed. In the present embodiment, the positioning hole 15b is formed such that it has a diameter of e.g. 5 mm, and the center thereof coincides with the center of the recess 15a. The light transmission layer 17 is a resin layer for protecting the thin films 16 formed on the substrate 15 and allowing transmission of a laser beam therethrough during reproduction of recorded data. For example, the light transmission layer 17 is coated with an ultraviolet-curing resin material by the spin-coating method, and formed to have a thickness of approximately 100 μm. Further, as shown in FIG. 3, the optical recording medium D2 is constructed by forming the central hole 18 having a diameter of approximately 15 mm through the central portion of the disk-shaped substrate D1. It should be noted that for ease of understanding of the present invention or simplicity, description of the construction of the thin films 16, etc. and the method of forming the same is omitted.

Referring to FIG. 1, the manufacturing apparatus 1 is comprised of a feed mechanism 2, the cut-forming machine 3, the punching machine 4, a collector 5, a cleaner 6, a delivery mechanism 7, a disk-detecting section 8, a transfer mechanism 9, a control section 10, an operating section 11, and a display 12. As shown in FIG. 4, the feed mechanism 2 includes a pivot arm 2b which is configured to be vertically movable and has a sucking portion 2a mounted at an end thereof, for holding the disk-shaped substrate D1 thereat by suction. The feed mechanism 2 feeds the disk-shaped substrate D1 from a stack location PS to a feed location P1 under the control of the control section 10. At the stack location PS, there are stacked a plurality of disk-shaped substrates D1, D1 . . . for which formation of a light transmission layer 17 is completed.

The cut-forming machine 3 includes a table 21, a cut-forming blade section 22, an urging portion 23, a spring 24, and a vertical movement mechanism 25, as shown in FIG. 5, and mounted at a cut-forming location P2, as shown in FIG. 4. The table 21 corresponds to a table in the present invention, and as shown in FIG. 5, supports a disk-shaped substrate D1 via an upper surface formed to be flat such that the disk-shaped substrate D1 can be placed thereon with its surface formed with the light transmission layer 17 facing upward. Further, a positioning protrusion 21a having a truncated conical shape is formed on a central portion of the upper surface of the table 21 in a manner protruding upward therefrom, for being fitted in the positioning hole 15b of the disk-shaped substrate D1, and thereby positioning the disk-shaped substrate D1 with respect to the table 21. Further, the table 21 is configured such that a plurality of suction holes 21b, 21b, . . . for attracting the disk-shaped substrate D1 thereto by sucking air existing between the upper surface of the table 21 and the lower surface of the disk-shaped substrate D1 are formed around the positioning protrusion 21a.

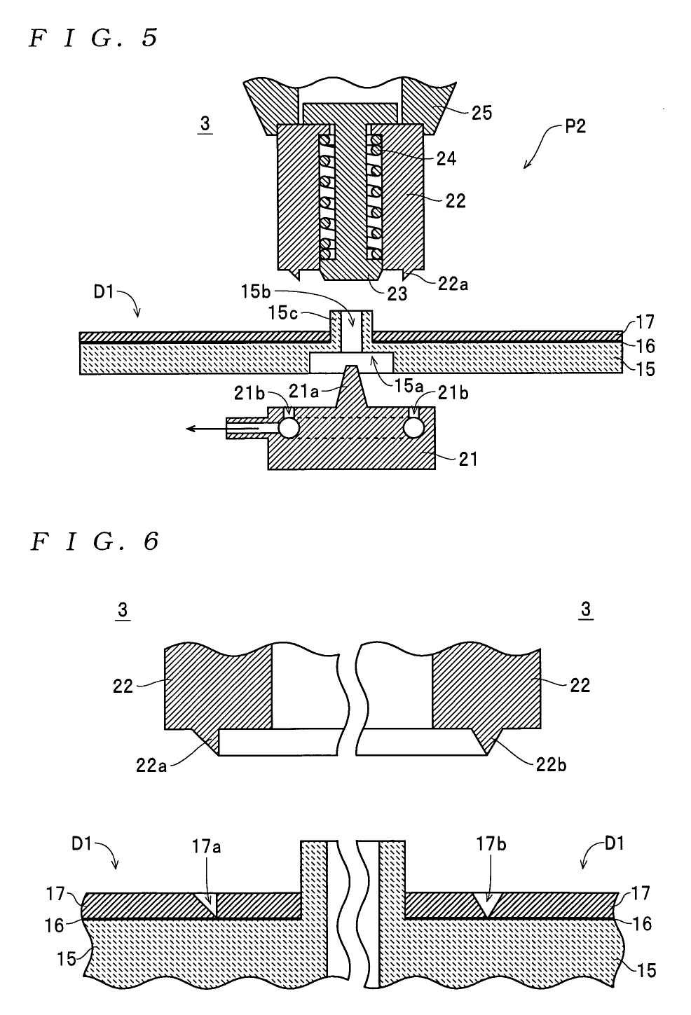

The cut-forming blade section 22 has a hollow cylindrical shape with its top end face formed flat for being mounted on the vertical movement mechanism 25, with a blade 22a formed on a bottom end face thereof in a protruding manner, for forming a cut 17a (see FIG. 7) in the light transmission layer 17 of the disk-shaped substrate D1. As shown in a left portion of FIG. 6, the blade 22a is a single-edged blade having an annular shape with a diameter of approximately 16 mm, larger than the diameter of the central hole 18, and has a cutting edge provided on an outer periphery thereof. Further, the height of the blade 22a is defined to be approximately 105 μm, which is equivalent (approximately equal) to the thickness (e.g. approximately 100 μm) of the light transmission layer 17, according to the depth of the cut 17a to be formed in the light transmission layer 17. It should be noted that the blade formed on the bottom end face of the cut-forming blade section 22 is not limited to a single-edged blade, as in the case of the blade 22a, but as shown in a right portion of FIG. 6, it can be formed by a double-edged blade 22b having cutting edges provided on both of the outer and inner peripheries thereof. In this case, when the double-edged blade 22b is pushed into the light transmission layer 17, a cut 17b in the form of a V-shaped groove is formed in the light transmission layer 17.

The urging portion 23 is disposed to extend through a central portion of the cut-forming blade section 22 in a state allowed to slide vertically, and urged toward the table 21 by the spring 24. When the cut-forming blade section 22 is moved downward by the vertical movement mechanism 25, the urging portion 23 urges the central portion (the upper end of the protrusion 15c) of the disk-shaped substrate D1 downward, thereby pressing the disk-shaped substrate D1 against the table 21. The spring 24, which corresponds to an urging device in the present invention, is implemented by a coil spring. Although the cut-forming machine 3 may be configured such that in place of the spring 24, air cylinders or an actuator urge(s) (press(es)) the urging portion 23, this complicates the control of operation of the urging portion 23, and increases the costs of components, and therefore, it is preferable to employ a coil spring as in the present embodiment. The vertical movement mechanism 25, which corresponds to a moving mechanism in the present invention, moves (moves downward) the cut-forming blade section 22 toward the disk-shaped substrate D1 on the table 21, thereby causing the blade 22a to be pushed into the light transmission layer 17 to form the cut 17a. Although the cut-forming machine 3 is configured in the present embodiment such that the cut-forming machine 3 moves (moves downward) the cut-forming blade section 22 toward the table 21, it may be configured such that the cut-forming blade section 22 is fixed at a predetermined location, and the table 21 with the disk-shaped substrate D1 placed thereon is moved (moved upward) toward the cut-forming blade section 22. Further, the cut-forming machine 3 may also be configured such that both of the table 21 and the cut-forming blade section 22 are moved toward each other.

As shown in FIG. 7, the punching machine 4 is comprised of a base 31, a punching blade section 32, a positioning protrusion 33, a spring 34, air cylinders 35, 35, . . . , a substrate-receiving table 36, an ultrasonic horn 37, an ultrasonic generator 38, and a vertical movement mechanism 39. As shown in FIG. 4, the punching machine 4 is disposed at a central hole-forming location P3. The punching blade section 32 is, as shown in FIG. 7, in the form of a bottomed hollow cylinder with an outer shape having a diameter (outer diameter) of 15 mm, equal to the inner diameter of the central hole 18, and rigidly fixed to the base 31. The punching blade section 32 is pressed (pushed) into the disk-shaped substrate D1 pushed downward by the vertical movement mechanism 39, to thereby punch the central hole 18 through the disk-shaped substrate D1. The positioning protrusion 33 in the form of a truncated conical shape is disposed within the punching blade section 32, and urged upward by the spring 34 such that the positioning protrusion 33 is fitted into the positioning hole 15b of the disk-shaped substrate D1, for positioning the disk-shaped substrate D1 with respect to the punching blade section 32.

For example, when the disk-shaped substrate D1 is moved downward, e.g. compressed air is supplied to an air chamber formed within the substrate-receiving table 36 by a pressure pump, not shown, whereby the air cylinders 35 allow the translating motion of the substrate-receiving table 36 in a direction indicated by an arrow A1 (in a downward direction) with respect to the base 31, whereas when the disk-shaped substrate D1 is moved upward, compressed air is supplied to an air chamber formed within the base 31 by the pressure pump, whereby the air cylinders 35 allow the translating motion of the substrate-receiving table 36 in a direction indicated by an arrow A2 (in an upward direction) with respect to the base 31. The substrate-receiving table 36 has a generally hollow cylindrical shape and is mounted to the base 31 via the air cylinders 35 such that the substrate-receiving table 36 can be moved upward and downward along the side surface of the punching blade section 32. The substrate-receiving table 36 has an upper surface thereof formed flat such that it can be brought into surface contact with the lower surface of the disk-shaped substrate D1 having the cut 17a formed in the upper surface thereof. Further, the substrate-receiving table 36 is formed with a plurality of suction holes 36a, 36a, . . . for attracting the disk-shaped substrate D1 thereto by sucking air between the upper surface of the substrate-receiving table 36 and the lower surface of the disk-shaped substrate D1. It should be noted that as shown in FIG. 7, the normal or unmoved position of the substrate-receiving table 36 in the direction of height thereof is defined as a position in which a cutting edge of the punching blade section 32 is inhibited from protruding from the upper surface of the substrate-receiving table 36.

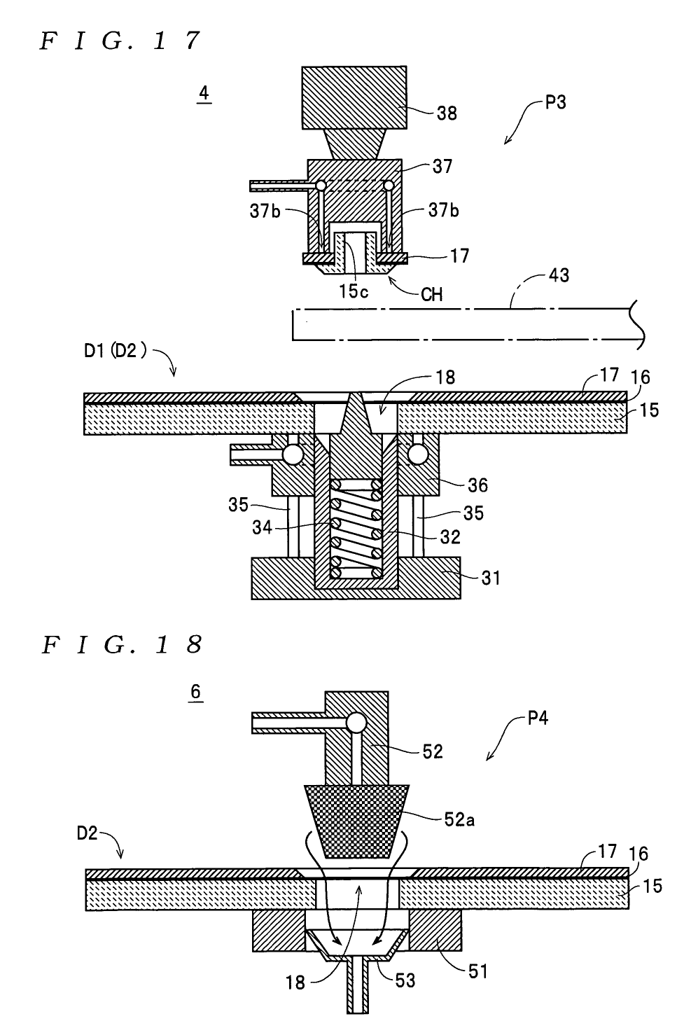

The ultrasonic horn 37 has a generally hollow cylindrical shape, and is mounted on the vertical movement mechanism 39 together with the ultrasonic generator 38, for transmitting ultrasonic waves generated by the ultrasonic generator 38 to the disk-shaped substrate D1 while urging on the upper surface of the disk-shaped substrate D1 downward, when the central hole 18 is formed. Further, the ultrasonic horn 37 has a lower surface thereof formed with a recess 37a into which the protrusion 15c of the disk-shaped substrate D1 can be inserted. Furthermore, the ultrasonic horn 37 is formed with a plurality of suction holes 37b, 37b, . . . for sucking air around the protrusion 15c of a punched piece CH (see FIG. 17) punched off by the punching blade section 32 (air on the upper surface of the light transmission layer 17) to thereby attract the punched piece CH thereto. The ultrasonic generator 38 generates ultrasonic waves under the control of the control section 10 to vibrate the ultrasonic horn 37, thereby applying ultrasonic vibration to the disk-shaped substrate D1 via the ultrasonic horn 37.

Referring to FIG. 8, the collector 5 is comprised of a moving mechanism 41, a collecting arm 43, and a slider 44, and disposed at a location on a side of the central hole-forming location P3 in which the punching machine 4 is mounted, as shown in FIG. 4. As shown in FIG. 8, the moving mechanism 41 causes the stay 42 to slide in directions indicated by arrows B1 and B2 in FIG. 8 (in the directions of moving toward and away from the punching machine 4), under the control of the control section 10. The collecting arm 43 is made by forming e.g. a metal plate which is surface-treated for reducing sliding resistance, such that it has a generally U-shaped cross section opening upward, and pivotally mounted on a pivot 42a of the stay 42 of the moving mechanism 41 via a stay 43a. Further, the collecting arm 43 includes a stay 43b rigidly fixed to a rear end thereof and a slide pin 43c attached to the stay 43b, and is urged e.g. by a helical spring, not shown, mounted around the pivot 42a in a direction indicated by an arrow C.

When the stay 42 is caused to slide by the moving mechanism 41 in the direction indicated by the arrow B1, the slide pin 43c is caused to slide along the underside surface of the slider 44 in a direction indicated by an arrow B3. At this time, while being changed from an inclined position indicated by solid lines to a horizontal position indicated by one-dot chain lines, the collecting arm 43 has its free end advanced into between the punched piece CH attracted by the ultrasonic horn 37 of the punching machine 4 and the optical recording medium D2 (the disk-shaped substrate D1 having the central hole 18 formed by punching). In this state, when the sucking or attraction of the punched piece CH by the ultrasonic horn 37 is stopped, the punched piece CH falls onto the free end of the collecting arm 43. Further, when the stay 42 is caused to slide by the moving mechanism 41 in the direction indicated by the arrow B2, the slide pin 43c is caused to slide along the underside surface of the slider 44 in a direction indicated by an arrow B4. In this case, while being changed from the horizontal position indicated by the one-dot chain lines to the inclined position indicated by the solid lines, the collecting arm 43 has its free end retracted from the upper surface of the optical recording medium D2. In this case, the punched piece CH having fallen onto the free end of the collecting arm 43 slides downward along the collecting arm 43 in a direction indicated by an arrow B5 to fall onto a predetermined collecting area.

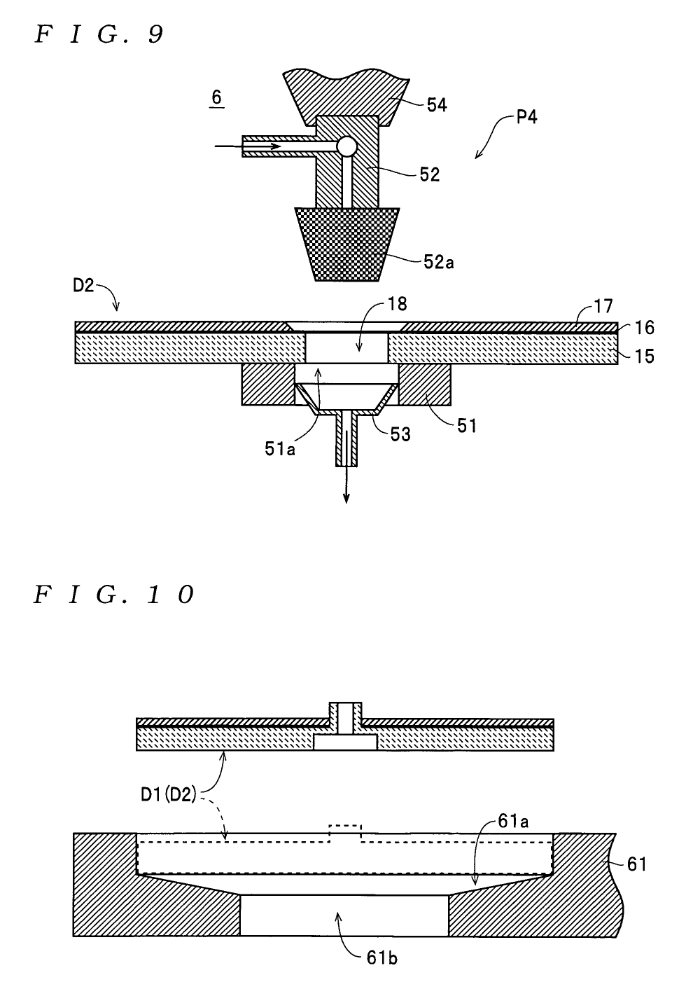

Referring to FIG. 9, the cleaner 6 is comprised of a table 51, a blowing section 52, a sucking section 53, and a vertical movement mechanism 54, and disposed at a cleaning location P4, as shown in FIG. 4. As shown in FIG. 9, the table 51 is configured to be capable of supporting the optical recording medium D2 placed thereon, and formed with a central hole 51a having a diameter larger than that of the central hole 18 and extending through a central portion thereof. The blowing section 52 has a nozzle 52a mounted on an end thereof, which is made of a porous material and has a truncated conical shape. The blowing section 52 is moved downward toward the optical recording medium D2 on the table 51 by the vertical movement mechanism 54. Further, the blowing section 52 blows compressed air supplied under pressure from a pressure pump (compressor), not shown, toward the optical recording medium D2 from the nozzle 52a. In the present embodiment, the nozzle 52a is formed such that the diameter of a distal end (lower end) thereof is smaller than that of the central hole 18, and the diameter of a root end (upper end) thereof is larger than that of the central hole 18. The sucking section 53 is disposed in the central hole 51a of the table 51, and connected to a suction pump, not shown, to thereby suck air from the vicinity of or through the central hole 18 of the optical recording medium D2 on the table 51. The cleaner 6 may also be configured such that only one of the blowing section 52 and the sucking section 53 is provided. Further, it is possible to blow gas, such as nitrogen gas, toward the optical recording medium D2 in place of the compressed air.

The delivery mechanism 7 includes a sucking section 7a mounted on a distal end thereof, for sucking the optical recording medium D2 thereto, and a pivot arm 7b constructed in a vertically movable fashion, as shown in FIG. 4. The delivery mechanism 7 transfers the optical recording medium D2 from a delivery location P5 to a stack location PE under the control of the control section 10. At the stack location PE, a plurality of optical recording media D2, D2 . . . , each having the central hole 18 formed therein (completed), are stacked. The disk-detecting section 8 is comprised of a light-emitting element and a light-receiving element, by way of example, and installed at a detecting location P6. When the optical recording medium D2 is transferred to the detecting location P6 by the transfer mechanism 9, the disk-detecting section 8 detects the optical recording medium D2 moving (passing) over the detecting location P6 from the delivery location P5 to the feed location P1, and delivers a signal indicative of the detection to the control section 10.

Referring to FIG. 1, the transfer mechanism 9 is comprised of a transfer stage 61, an indexing mechanism 62, and a vertical movement mechanism 63. As shown in FIG. 4, the transfer stage 61 is generally disk-shaped, and mounted on the indexing mechanism 62 via a rotational shaft 62a. Further, the transfer stage 61 is formed with six disk-placing recesses 61a, 61a, . . . each capable of having a disk-shaped substrate D1 (optical recording medium D2) placed therein. The disk-placing recesses 61a, 61a, . . . are formed at respective locations at the same distance from the center of the transfer stage 61, and at the same time at circumferentially equal intervals. Further, as shown in FIG. 10, each disk-placing recess 61a has a bottom thereof formed with a working hole 61b for enabling the cut-forming machine 3, the punching machine 4, or the like to be brought into abutment with the lower surface of the disk-shaped substrate D1 (optical recording medium D2) placed in the disk-placing recess 61a. The indexing mechanism 62 intermittently rotates i.e. indexes the transfer stage 61 under the control of the control section 10 each time through 60 degrees in a direction indicated by an arrow E in FIG. 4, to thereby transfer the disk-shaped substrate D1 (optical recording medium D2) placed in the disk-placing recess 61a of the transfer stage 61 sequentially to the feed location P1, the cut-forming location P2, the central hole-forming location P3, the cleaning location P4, and the delivery location P5. The vertical movement mechanism 63 moves the transfer stage 61 upward and downward under the control of the control section 10, to thereby move the disk-shaped substrates D1 (optical recording media D2) placed on the transfer stage 61 upward and downward with respect to the cut-forming machine 3, the punching machine 4, and so forth.

The control section 10 controls the operations of the feed mechanism 2, the cut-forming machine 3, the punching machine 4, the collector 5, the cleaner 6, the delivery mechanism 7, and the transfer mechanism 9. Further, when a predetermined signal is output by the disk-detecting section 8, the control section 10 carries out a stop process for stopping the operation of the manufacturing apparatus 1. The operating section 11 includes a start button for starting manufacturing of optical recording media D2 by the manufacturing apparatus 1, a stop button for stopping the operation of the manufacturing apparatus 1, and so forth, neither of which is shown. The display 12 displays various kinds of information e.g. concerning operating states of the manufacturing apparatus 1 under the control of the control section 10.

Next, a method of manufacturing the optical recording media D2 by the manufacturing apparatus 1 will be described with reference to drawings. It is assumed here that the manufacturing of the disk-shaped substrate D1 (injection molding of the substrate 15, and formation of the thin films 16 and the light transmission layer 17 on the upper surface of the substrate 15) has already been completed, and a plurality of disk-shaped substrates D1, D1 . . . are stacked at the stack location PS.

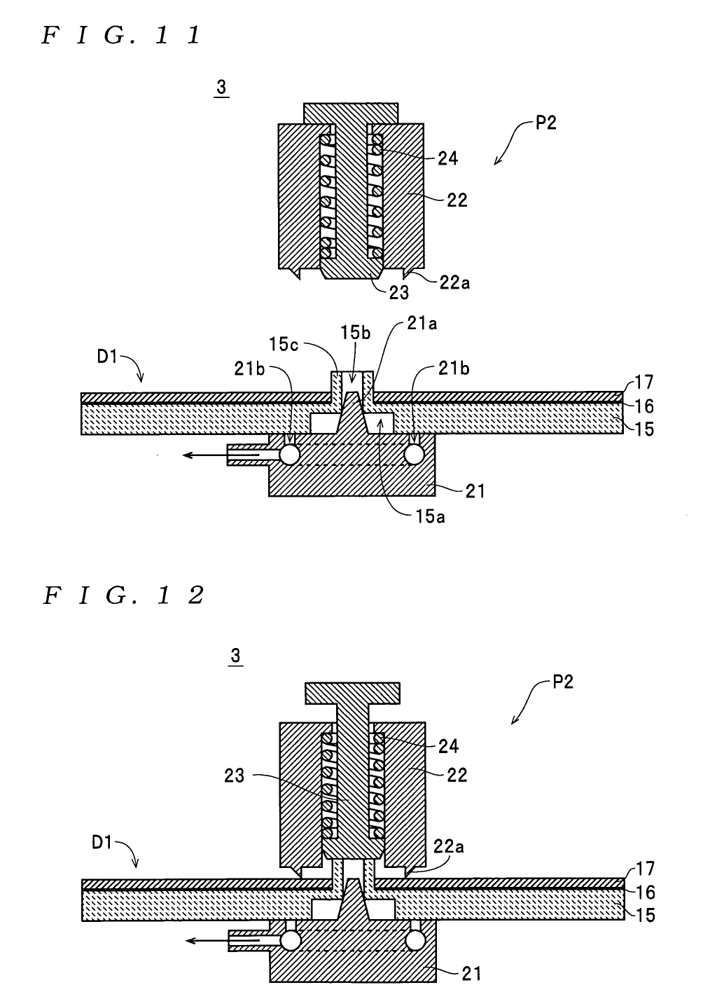

When the start button of the operating section 11 is operated by an operator, first, the control section 10 causes the feed mechanism 2 to feed one of the disk-shaped substrates D1 from the stack location PS to the feed location P1. In doing this, first, the feed mechanism 2, after pivoting the pivot arm 2b to the stack location PS and then moving the same downward, sucks a central portion (around the protrusion 15c) of the upper surface of the disk-shaped substrate D1 thereto by the sucking portion 2a. Then, after moving the pivot arm 2b upward, pivoting the same to the feed location P1, and then moving the same downward, the feed mechanism 2 stops the sucking of the disk-shaped substrate D1 by the sucking portion 2a, at a location upward of the disk-placing recess 61a of the transfer stage 61. Thus, as indicated by broken lines in FIG. 10, the feed of the disk-shaped substrate D1 onto the transfer stage 61 (feed of the disk-shaped substrate D1 onto the feed location P1) is completed. Then, the control section 10 causes the transfer mechanism 9 to transfer the disk-shaped substrate D1 placed on the transfer stage 61 from the feed location P1 to the cut-forming location P2. In doing this, in the transfer mechanism 9, first, the vertical movement mechanism 63 lifts the transfer stage 61, then the indexing mechanism 62 rotates the transfer stage 61 through 60 degrees in the direction indicated by the arrow E shown in FIG. 4, and thereafter the vertical movement mechanism 63 lowers the transfer stage 61. Thus, the transfer of the disk-shaped substrate D1 from the feed location P1 to the cut-forming location P2 is completed. In this case, as shown in FIG. 11, when the disk-shaped substrate D1 transferred to the cut-forming location P2 by the transfer mechanism 9 is lowered by the vertical movement mechanism 63, the positioning protrusion 21a of the table 21 is fitted into the positioning hole 15b of the disk-shaped substrate D1 from the lower surface side thereof, whereby the central portion of the disk-shaped substrate D1 is aligned with (positioned with respect to) the central portion of the table 21. As a result, when a cut 17a is formed, as described hereinafter, the blade 22a is pushed into the light transmission layer 17 in a state where the central portion of the cut-forming blade section 22 and the central portion of the disk-shaped substrate D1 on the table 21 are aligned with each other. It should be noted that for ease of understanding of the present invention, the illustration of the transfer stage 61 etc. is omitted in FIGS. 11 to 19 with reference to which the present embodiment is described.

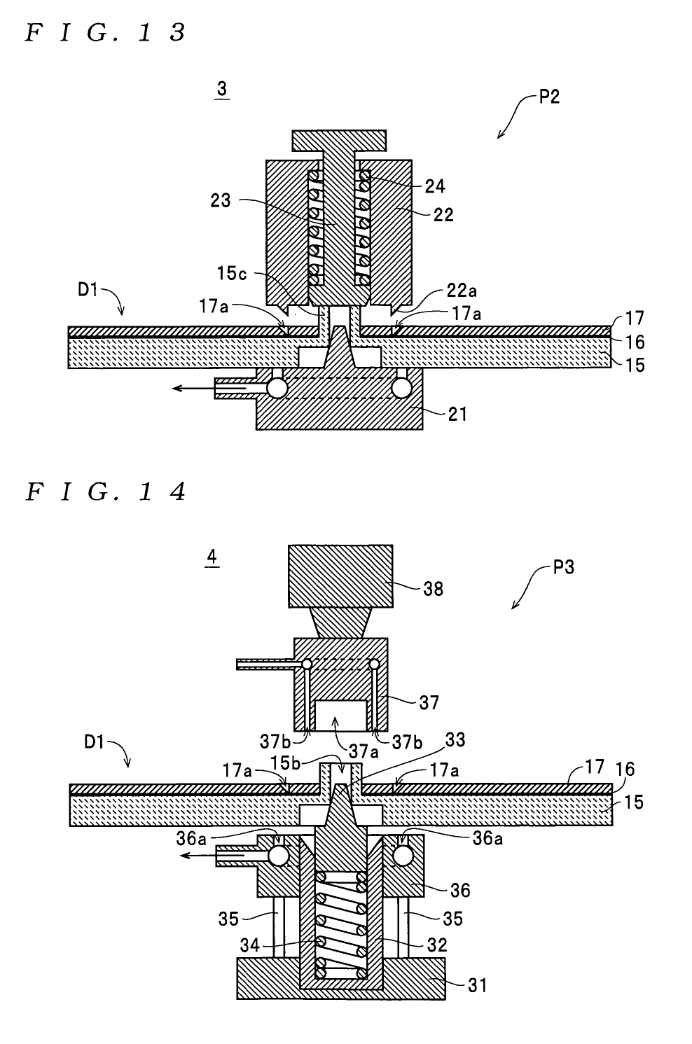

Next, the control section 10 causes the cut-forming machine 3 to form a cut 17a in the light transmission layer 17 of the disk-shaped substrate D1. More specifically, first, the control section 10 causes a suction pump, not shown, to operate for sucking air between the lower surface of the disk-shaped substrate D1 and the upper surface of the table 21 through the suction holes 21b, 21b, . . . Thus, the lower surface of the disk-shaped substrate D1 (around the recess 15a) is brought into intimate contact with the upper surface of the table 21 whereby the disk-shaped substrate D1 is held. Next, the control section 10 causes the vertical movement mechanism 25 to move the cut-forming blade section 22 downward toward the disk-shaped substrate D1. In this case, as the cut-forming blade section 22 is moved downward, first, the lower end face of the urging portion 23 is brought into abutment with the upper end of the protrusion 15c, and in this state, the cut-forming blade section 22 is moved further downward, whereby the spring 24 is compressed. As a result, the urging portion 23 is urged toward the table 21 by the extension force of the spring 24, and the central portion (portion in the vicinity of the protrusion 15c) of the disk-shaped substrate D1 is pressed against the upper surface of the table 21. Then, when the cut-forming blade section 22 is moved further downward by the vertical movement mechanism 25, as shown in FIG. 12, the cutting edge of the blade 22a is brought into abutment with the upper surface of the light transmission layer 17 of the disk-shaped substrate D1, and when the cut-forming blade section 22 is moved further downward, the blade 22a is pushed into the light transmission layer 17. In this case, since the height of the blade 22a is defined such that it is equivalent to the thickness of the light transmission layer 17, if the cut-forming blade section 22 is moved downward until the bottom end face of the cut-forming blade section 22 is brought into abutment with the upper surface of the light transmission layer 17, the cutting edge of the blade 22a reaches the upper surface of the substrate 15. Thus, in the light transmission layer 17, there is formed a circular cut 17a (see FIG. 13) which has a diameter approximately equal to the diameter (16 mm, in the illustrated example) of the blade 22a, and at the same time has a depth approximately equal to the thickness of the light transmission layer 17.

Then, as shown in FIG. 13, the control section 10 causes the vertical movement mechanism 25 to move the cut-forming blade section 22 upward. At this time, the spring 24 is progressively extended while continuing to urge the urging portion 23 toward the table 21, so that the blade 22a of the cut-forming blade section 22 is removed from the light transmission layer 17 with the disk-shaped substrate D1 being pressed against the table 21 by the urging portion 23. This makes it possible to avoid the inconvenience that the disk-shaped substrate D1 with the blade 22a stuck therein is moved upward (moved) together with the cut-forming blade section 22. In this case, the spring 24 continues to urge the urging portion 23 toward the table 21 from a time point at which the urging portion 23 is brought into abutment with the upper end of the protrusion 15c by the downward movement of the cut-forming blade section 22 caused by the vertical movement mechanism 25, to a time point at which the urging portion 23 is separated from the upper end of the protrusion 15c by the upward movement of the cut-forming blade section 22 caused by the vertical movement mechanism 25 (an example of “from at least a time point of completion of pushing the cut-forming blade section into the resin layer by the moving mechanism to a time point of removal of the cut-forming blade section from the resin layer by the moving mechanism” in the present invention). Further, since the disk-shaped substrate D1 continues to be sucked to the table 21 during the urging operation of the urging portion 23, it is possible to positively avoid the inconvenience that the disk-shaped substrate D1 with the blade 22a stuck therein is moved upward together with the cut-forming blade section 22. Thus, formation of the cut 17a in the disk-shaped substrate D1 is completed.

In the cut-forming machine 3, since the blade 22a of the cut-forming blade section 22 is a single-edged blade with a cutting edge provided on the outer periphery thereof, it is possible to avoid the inconvenience that when the cut-forming blade section 22 is moved upward, an outer part of the light transmission layer 17 with respect to the cut 17a is peeled off the substrate 15 in a state of the outer part being caught by the outer peripheral surface of the blade 22a. In this case, when the cut-forming blade section 22 is moved upward, an inner part of the light transmission layer 17 with respect to inner periphery of the blade 22a can be peeled off the substrate 15 in a state of the inner part being caught by the inner peripheral surface of the blade 22a. However, since the related portion (punched piece CH) is disposed of after manufacturing the optical recording medium D2, there occurs no problem. Further, if the cut-forming blade section 22 formed with the blade 22b (double-edged blade) shown by the right portion of FIG. 6 is used in place of the blade 22a, both inner and outer parts of the light transmission layer 17 with respect to the periphery of the blade 22b are prevented from being peeled off. On the other hand, the control section 10 causes the feed mechanism 2 to feed a new disk-shaped substrate D1 from the stack location PS to the feed location P1 in parallel with the operation of forming the cut 17a by the cut-forming machine 3 at the cut-forming location P2.

Then, the control section 10 stops the suction pump, thereby stopping the sucking of the disk-shaped substrates D1 to the table 21, and then causes the transfer mechanism 9 to transfer the disk-shaped substrate D1 having the cut 17a formed therein, from the cut-forming location P2 to the central hole-forming location P3. While the disk-shaped substrate D1 formed with the cut 17a is transferred, the new disk-shaped substrate D1 fed to the feed location P1 is transferred from the feed location P1 to the cut-forming location P2 in accordance with rotation of the transfer stage 61. On the other hand, as shown in FIG. 14, the disk-shaped substrate D1 formed with the cut 17a transferred to the central hole-forming location P3 has the positioning protrusion 33 fitted into the positioning hole 15b thereof from the lower surface side of the disk D1 along with the downward movement of the transfer stage 61, whereby the center of the disk-shaped substrate D1 is substantially aligned with the center of the punching blade section 32. Subsequently, the control section 10 causes the punching machine 4 to form a central hole 18 in the central portion of the disk-shaped substrate D1. More specifically, first, the control section 10 causes the vertical movement mechanism 39 to move the ultrasonic generator 38 and the ultrasonic horn 37 downward toward the disk-shaped substrate D1. In doing this, first, the bottom surface of the ultrasonic horn 37 is brought into abutment with the upper surface of the disk-shaped substrate D1, and in this state, when the ultrasonic horn 37 is moved further downward, the disk-shaped substrate D1 is moved downward while the spring 34 is compressed. Further, the control section 10 causes the suction pump, not shown, to operate for sucking air between the lower surface of the disk-shaped substrate D1 and the upper surface of the substrate-receiving table 36 through the suction holes 36a, 36a . . .

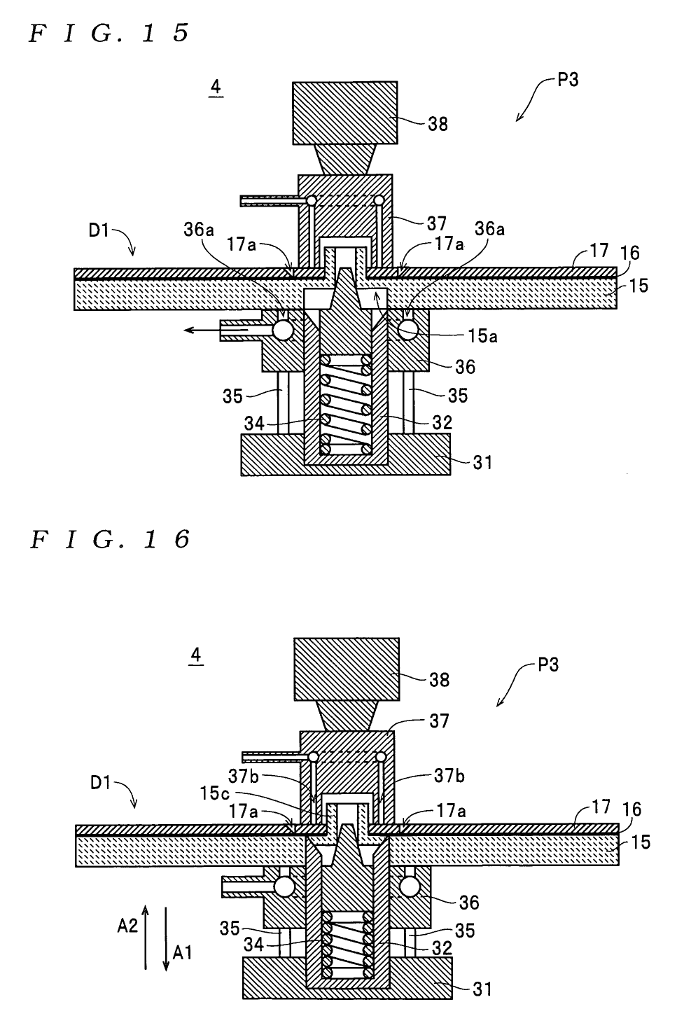

Next, when the disk-shaped substrate D1 is moved further downward by the vertical movement mechanism 39, the spring 34 is further compressed and the positioning protrusion 33 causes the center of the disk-shaped substrate D1 to be aligned with (positioned with respect to) the center of the punching blade section 32. In this state, as shown in FIG. 15, the lower surface of the disk-shaped substrate D1 is brought into intimate contact with the upper surface of the substrate-receiving table 36, whereby the disk-shaped substrate D1 is held by the substrate-receiving table 36. Then, the control section 10 causes the ultrasonic generator 38 to generate ultrasonic waves, while causing the vertical movement mechanism 39 to continue to move the disk-shaped substrate D1 downward. In this case, the ultrasonic horn 37 is caused to perform ultrasonic vibration by the ultrasonic waves generated by the ultrasonic generator 38, and the vibration is transmitted to the disk-shaped substrate D1. Subsequently, when the disk-shaped substrate D1 is moved further downward by the vertical movement mechanism 39, the substrate-receiving table 36 is moved downward together with the disk-shaped substrate D1 such that the air cylinders 35, 35, . . . are compressed, whereby the cutting edge of the punching blade section 32 enters the recess 15a of the disk-shaped substrate D1. At this time, since the outer diameter (e.g. 15.04 mm) of the punching blade section 32 is slightly smaller than the inner diameter (e.g. 15.06 mm) of the recess 15a, the punching blade section 32 is moved upward relative to the disk-shaped substrate D1 without rubbing the outer peripheral surface thereof against the inner wall surface of the recess 15a.

Then, after the disk-shaped substrate D1 is moved further downward by the vertical movement mechanism 39, thereby causing the cutting edge of the punching blade section 32 to be brought into abutment with the bottom surface of the recess 15a, as shown in FIG. 16, the disk-shaped substrate D1 is moved further downward, whereby the cutting edge of the punching blade section 32 is pushed into the substrate 15. At this time, since the disk-shaped substrate D1 is caused to perform ultrasonic vibration by the ultrasonic waves transmitted via the ultrasonic horn 37, the cutting edge of the punching blade section 32 is smoothly pushed into the substrate 15. Further, since the substrate 15 has the recess 15a formed therein when it is prepared, it is possible to form the central hole 18 by punching a portion having a far smaller thickness compared with the case of punching a substrate without the recess 15a.

Next, the control section 10 causes the suction pump, not shown, to operate for sucking air between the front surface (around the protrusion 15a) of the disk-shaped substrate D1 and the underside surface of the ultrasonic horn 37 through the suction holes 37b, 37b . . . As a result, the punched piece CH (see FIG. 17) punched off by the punching blade section 32 is sucked (held) by the ultrasonic horn 37. Then, the control section 10 causes the vertical movement mechanism 39 to move the ultrasonic generator 38 and the ultrasonic horn 37 upward. At this time, the disk-shaped substrate D1 is moved upward along with the upward movement of the ultrasonic horn 37, whereby the air cylinders 35, 35, . . . are extended to move the substrate-receiving table 36 upward for translating motion. Further, when the ultrasonic horn 37 is moved further upward to fully extend the air cylinders 35, 35, . . . , as shown in FIG. 17, the punched piece CH sucked to the ultrasonic horn 37 is separated from the disk-shaped substrate D1 (substrate 15) and moved upward together with the ultrasonic horn 37. At this time, sine the disk-shaped substrate D1 is sucked and held at the substrate-receiving table 36, it is possible to avoid the inconvenience that the disk-shaped substrate D1 is moved upward together with the punched piece CH and the ultrasonic horn 37. Thus, formation of the central hole 18 through the disk-shaped substrate D1 is completed (in the following description, the disk-shaped substrate D1 having the central hole 18 formed therethrough is also referred to as the “optical recording medium D2”). It should be noted that the control section 10 causes the cut-forming machine 3 to form the cut 17a at the cut-forming location P2 in parallel with the operation of forming the central hole 18 by the punching machine 4 at the central hole-forming location P3, and at the same time causes the feed mechanism 2 to feed a new disk-shaped substrate D1 from the stack location PS to the feed location P1.

Then, the control section 10 causes the collector 5 to collect the punched piece CH. More specifically, the control section 10 causes the moving mechanism 41 of the collector to slide the stay 42 in the direction indicated by the arrow B1 in FIG. 8, thereby causing the free end of the collecting arm 43 to advance between the optical recording medium D2 on the substrate-receiving table 36 and the punched piece CH sucked to the ultrasonic horn 37, as indicated by one-dot chain lines in FIG. 17. Then, the control section 10 stops the operation of the suction pump, thereby stopping the sucking of the punched piece CH by the ultrasonic horn 37, whereupon the punched piece CH sucked by the ultrasonic horn 37 is dropped off onto the collecting arm 43. Subsequently, the control section 10 causes the moving mechanism 41 of the collector 5 to slide the stay 42 in the direction indicated by the arrow B2 in FIG. 8, thereby retracting the collecting arm 43. This causes the collecting arm 43 to be inclined, whereby the punched piece CH is slid downward from the free end of the collecting arm 43 in the direction of the root end thereof to be dropped to a predetermined collecting location. Thus, the collection of the punched piece CH is completed.

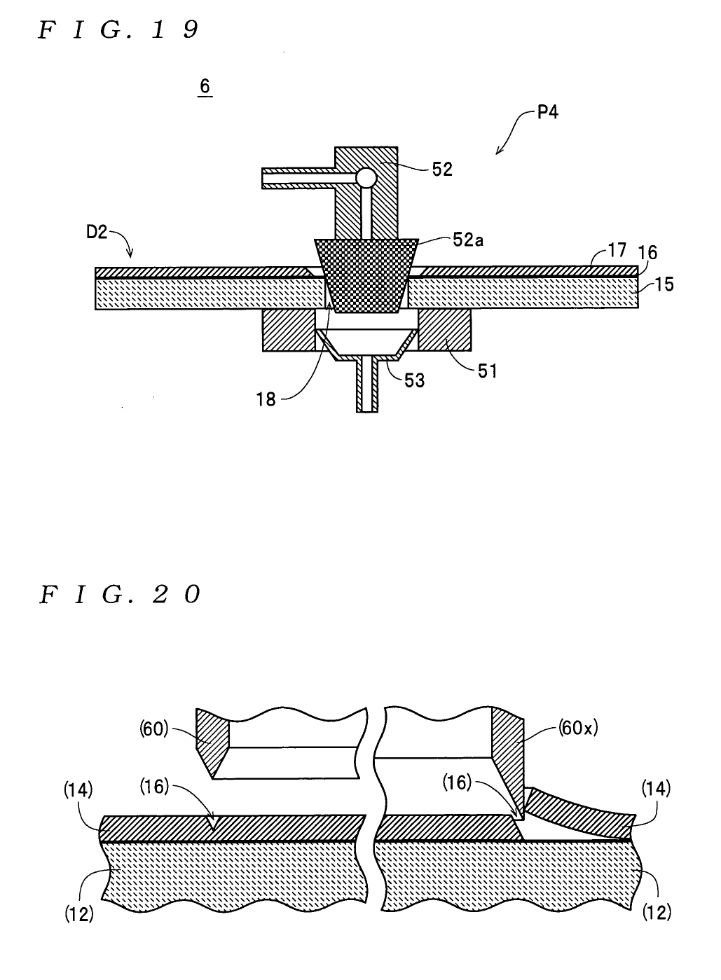

Next, the control section 10 causes the transfer mechanism 9 to transfer the optical recording medium D2 having the central hole 18 formed therethrough, from the central hole-forming location P3 to the cleaning location P4. At this time, the disk-shaped substrate D1 fed to the feed location P1 by the feed mechanism 2 is transferred from the feed location P1 to the cut-forming location P2 in accordance with rotation of the transfer stage 61, while the disk-shaped substrate D1 having the cut 17a formed by the cut-forming machine 3 is transferred from the cut-forming location P2 to the central hole-forming location P3. In this case, as shown in FIG. 18, the optical recording medium D2 transferred to the cleaning location P4 is placed on the table 51 of the cleaner 6 along with the downward movement of the transfer stage 61. Then, the control section 10 causes the cleaner 6 to clean a portion of the optical recording medium D2 in the vicinity of the central hole 18. More specifically, first, the control section 10 causes the pressure pump to operate to deliver compressed air from the nozzle 52a of the blowing section 52 for blowing, and at the same time causes the suction pump to operate to draw air from the vicinity of the central hole 18 of the optical recording medium D2 via the sucking section 53. Next, the control section 10 causes the vertical movement mechanism 54 to move the blowing section 52 downward. This causes the blowing section 52 to come closer to the optical recording medium D2, so that cuttings generated by punching and adhering to the periphery of the central hole 18 are blown away by the compressed air delivered from the nozzle 52a, and at the same time the cuttings are sucked into the sucking section 53 together with the air drawn from the vicinity of the central hole 18. Further, as shown in FIG. 19, when the blowing section 52 is moved further downward to bring the outer periphery of the nozzle 52a into abutment with the rim of the central hole 18, the control section 10 stops the pressure pump for a predetermined time period. Then, after the lapse of the predetermined time period, the control section 10 causes the pressure pump to operate again, and at the same time causes the vertical movement mechanism 54 to move the blowing section 52 upward. Thus, cleaning of the portion of the optical recording medium D2 in the vicinity of the central hole 18 is completed.

Next, the control section 10 causes the transfer mechanism 9 to transfer the optical recording medium D2 having the central hole 18 cleaned, from the cleaning location P4 to the delivery location P5. At this time, the disk-shaped substrate D1 fed to the feed location P1 by the feed mechanism 2 is transferred from the feed location P1 to the cut-forming location P2 in accordance with rotation of the transfer stage 61, and the disk-shaped substrate D1 having the cut 17a formed by the cut-forming machine 3 is transferred from the cut-forming location P2 to the central hole-forming location P3. Further, the optical recording medium D2 having the central hole 18 formed by the punching machine 4 is transferred from the central hole-forming location P3 to the cleaning location P4 at the same time. Then, the control section 10 causes the delivery mechanism 7 to deliver the optical recording medium D2 transferred to the delivery location P5, to the stack location PE. In doing this, first, the delivery mechanism 7 causes the pivot arm 7b to pivot to the delivery location P5, and move downward, thereafter causing the sucking section 7a to suck the central portion (around the central hole 18) of the front surface of the optical recording medium D2 thereto. Then, the delivery mechanism 7 causes the pivot arm 7b to move upward, pivot to the stack location PE, and move downward, thereafter stopping the sucking section 7a from sucking the optical recording medium D2. Thus, delivery of the optical recording medium D2 is completed.

Thereafter, the control section 10 alternately and repeatedly carries out the operations of feed of a disk-shaped substrate D1 by the feed mechanism 2, formation of a cut 17a by the cut-forming machine 3, formation of a central hole 18 by the punching machine 4, cleaning of an optical recording medium D2 by the cleaner 6, and delivery of the optical recording medium D2 by the delivery mechanism 7, and the operation of transfer (rotation of the transfer stage 61) of disk-shaped substrates D1, D1 . . . , and optical recording media D2, D2 . . . , by the transfer mechanism 9. Further, for example, when there is an optical recording medium D2 transferred to the detecting location P6 by the rotation of the transfer stage 61 without being delivered from the transfer stage 61 owing to insufficient suction or attraction of the optical recording medium D2 by the sucking section 7a, the disk-detecting section 8 delivers the predetermined signal to the control section 10. In this case, the control section 10 executes the stop process for stopping the operations of the feed mechanism 2, the cut-forming machine 3, the punching machine 4, the collector 5, the cleaner 6, the delivery mechanism 7, and the transfer mechanism 9, while causing the display 12 to display an error message to the effect that the optical recording medium D2 has not been delivered, and at the same time causing a loudspeaker, not shown, to produce an alarm sound. This causes the operator to recognize that the optical recording medium D2 has not been delivered, so that the operator removes the optical recording medium D2 from the transfer stage 61 (the detecting location P6). This makes it possible to avoid the inconvenience that a new disk-shaped substrate D1 is fed onto the optical recording medium D2 left undelivered from the transfer stage 61. Further, after the optical recording medium D2 is removed from the transfer stage 61, the operator operates the start button of the operating section 11. In response to this, the control section 10 causes the manufacturing apparatus 1 to resume the process for manufacturing optical recording media D2.

As described hereinabove, according to the manufacturing apparatus 1, the spring 24 causes the urging portion 23 to urge the disk-shaped substrate D1 toward the table 21 from at least a time point of completion of pushing the cut-forming blade section 22 into the light transmission layer 17 by the vertical movement mechanism 25, to a time point of removal of the cut-forming blade section 22 from the light transmission layer 17 by the vertical movement mechanism 25. With the relatively simple construction described above, it is possible to avoid the inconvenience that when the cut-forming blade section 22 is moved upward, the disk-shaped substrate D1 having the blade 22a stuck therein is moved upward together therewith. Therefore, it is no longer necessary, for example, for an operator to remove the disk-shaped substrate D1 from the cut-forming blade section 22 by manual operation, so that it is possible to further enhance the manufacturing efficiency of optical recording media D2.

Further, according to the manufacturing apparatus 1, since the urging device (spring 24) in the present invention is implemented by a coil spring, the control of operation of the urging device becomes unnecessary, differently from the construction in which air cylinders or an actuator urge(s) the urging portion 23. Moreover, it is possible to manufacture the cut-forming machine 3 and the manufacturing apparatus 1 at lower costs.

Furthermore, according to the manufacturing apparatus 1, the positioning protrusion 21a for being fitted into the positioning hole 15b formed in the central portion of the disk-shaped substrate D1 is formed on the central portion of the table 21 in a manner protruding therefrom, whereby in forming a cut 17a, it is possible to push the blade 22a into the light transmission layer 17 in the state where the central portion of the cut-forming blade section 22 is aligned with the central portion of the disk-shaped substrate D1 on the table 21, so that it is possible to positively avoid the inconvenience that the cut 17a is formed off-center with respect to the central portion of the disk-shaped substrate D1.

Further, according to the manufacturing apparatus 1, the bottom end face of the cut-forming blade section 22 formed with the annular blade 22a (22b) that protrude by a length (to a height) equivalent to the thickness of the light transmission layer 17 is moved such that the bottom end face is brought into surface contact with the upper surface of the light transmission layer 17. This makes it possible to accurately and easily form the cut 17a having a desired depth while dispensing with complicated height control and the like.

Furthermore, according to the manufacturing apparatus 1, either of a single-edged blade (blade 22a) having a cutting edge provided on the outer periphery thereof, and a double-edged blade (blade 22b) having cutting edges provided on both of the outer and inner peripheries thereof is formed on the cut-forming blade section 22. This makes it possible to avoid the inconvenience that when the cut-forming blade section 22 is moved upward, an outer part of the light transmission layer 17 with respect to the cut 17a is peeled off the substrate 15 in a state of the part being caught by the outer peripheral surface of the blade 22a (22b).

It should be noted that the present invention is by no means limited to the aforementioned embodiment. For example, although in the above embodiment, the blade 22a of the cut-forming blade section 22 is formed to have a height (105 μm) equivalent to the thickness (100 μm) of the light transmission layer 17, this is not limitative, but if the blade 22a is formed to have a height (e.g. approximately 120 μm) slightly larger than the thickness of the light transmission layer 17, it is possible to form a cut 17a in a manner such that the cutting edge of the blade 22a is pushed into the substrate 15. This makes it possible to cut the light transmission layer 17 more reliably, whereby it is possible to positively avoid the inconvenience that a portion of the light transmission layer 17 which should be punched off together with the substrate 15 in forming the central hole 18 is left around the periphery of the central hole 18. Further, although in the above embodiment, description has been given of a configuration that a cut 17a having a desired depth is formed by defining the height of the blade 22a of the cut-forming blade section 22 such that it is equivalent to the thickness of the light transmission layer 17, this is not limitative, but it is also possible to form a cut 17a having a desired depth by forming a cut-forming blade section having a blade with a height sufficiently larger than the thickness of the light transmission layer 17 and adjusting the amount of movement of the cut-forming blade section moved by the vertical movement mechanism 25, as required.

What is claimed is:

1. A cut-forming machine for forming a circular cut in a resin layer formed on one side of a disk-shaped substrate to be formed with a central hole by a punching machine, such that the circular cut has a diameter larger than a diameter of the central hole and surrounds a portion of the disk-shaped substrate where the central hole is to be formed,
the cut-forming machine comprising:
a table for supporting the disk-shaped substrate with the resin layer facing upward;
a cut-forming blade section for forming the cut in the resin layer by being pushed into the resin layer, said cut-forming blade section having a hollow cylindrical shape;
a moving mechanism for moving at least one of said table and said cut-forming blade section toward the other of said table and said cut-forming blade section, thereby pushing said cut-forming blade section into the resin layer;
an urging portion that is disposed in a central portion of said cut-forming blade section such that said urging portion is allowed to slide in directions of movement of the at least one of said table and said cut-forming blade section, caused by said moving mechanism, toward and away from the other of said table and said cut-forming blade section; and
an urging device for urging said urging portion, from at least a time point of completion of pushing said cut-forming blade section into the resin layer by said moving mechanism to a time point of removal of said cut-forming blade section from the resin layer by said moving mechanism, thereby causing said urging portion to urge a central portion of the disk-shaped substrate toward said table.

2. A cut-forming machine as claimed in claim 1, wherein said urging device is implemented by a coil spring.

3. A cut-forming machine as claimed in claim 1, wherein said table has a positioning protrusion formed on a central portion thereof in a manner protruding therefrom, for being fitted into a positioning hole that is formed in the central portion of the disk-shaped substrate and has a diameter smaller than the diameter of the central hole.

4. A cut-forming machine as claimed in claim 1, wherein said cut-forming blade section has an annular blade formed on a bottom surface thereof such that said annular blade protrudes from the bottom surface by a length equivalent to a thickness of the resin layer, and
wherein said moving mechanism moves said cut-forming blade section such that the bottom surface of said cut-forming blade section is brought into surface contact with the surface of the resin layer.

5. A cut-forming machine as claimed in claim 1, wherein said cut-forming blade section is formed with either a single-edged blade having a cutting edge formed on an outer periphery thereof, or a double-edged blade having cutting edges formed on both of the outer periphery and an inner periphery thereof.

6. An optical recording medium-manufacturing apparatus for manufacturing an optical recording medium by forming the central hole in the disk-shaped substrate, comprising:
the cut-forming machine as claimed in any one of claims 1 to 5; and
the punching machine having a punching blade section for being pushed into the portion of the disk-shaped substrate where the central hole is to be formed, for punching the central hole.
